(19) United States
(12) Patent Application Publication
(10) Pub. No.: US 2023/0212433 A1
(43) Pub. Date: Jul. 6, 2023

(54) TAPE TO MASK A STRUCTURE

(71) Applicant: Randall S. Belter, Green Bay, WI (US)

(72) Inventor: Randall S. Belter, Green Bay, WI (US)

(21) Appl. No.: 17/565,930

(22) Filed: Dec. 30, 2021

(51) Int. Cl. C09J 7/38; C09J 7/29; B29C 65/00; C09J 5/00; B29C 65/50

(52) U.S. Cl. CPC C09J 7/38; C09J 7/29; B29C 66/43; C09J 5/00; B29C 65/5007; B29C 65/5057; C09J 2301/21; C09J 2400/283; C09J 2301/204; C09J 2203/31

(57) ABSTRACT

Tape and method to mask a structure. The tape includes a base layer having length, width, outside surface, inside surface, and top edge spaced from bottom edge. A first portion of the width of the inside surface includes a first tacky adhesive layer connected to the inside surface and located adjacent the top edge. A second portion of the width of the inside surface includes a second tacky adhesive layer connected to the inside surface and located adjacent the bottom edge. At least a portion of the base layer includes a water impermeable area that prevents water adjacent the outside surface from reaching the inside surface by passing through the base layer. And, a third portion of the width of the inside surface of the base layer includes a non-tacky area located between the first tacky adhesive layer and the second tacky adhesive layer.

### TECHNICAL FIELD

This invention generally relates to material used to mask a structure like a surface, and more particularly to a tape like material with select tacky adhesive area(s) and at least one non-tacky area, where the material can be torn or cut apart as it is prepared for use to cover or mask a structure like the surface of a wall, window, building or other structure.

### BACKGROUND

A variety of materials have been used to cover or mask surfaces for temporary to permanent purposes. For example, there is conventional masking tape made of a creeped paper base layer and having one surface completely coated with tacky adhesive. There is also a material known as painter's tape that can be similar to the masking tape, but only an edge portion of one surface of the material is coated with tacky adhesive and the other portion of that same surface is non-tacky. However, when trying to mask a structure while also being able to more fully cover the structure with a sheeting connected to the tape material, no existing masking material can do the job. Accordingly, there is a need to address one or more of the deficiencies in the art to better aid in achieving more desirable requirements for masking materials and avoiding negative ones, especially when trying to use both a masking material and a sheet material secured thereto.

### SUMMARY

To address one or more deficiencies in the art and/or better achieve the desirable requirements for masking surfaces of a structure as taught herein, there is provided a tape to mask a structure. The tape includes a base layer having a length, a width, an outside surface, an inside surface, and a top edge spaced from a bottom edge. A first portion of the width of the inside surface of the base layer includes a first tacky adhesive layer connected to the inside surface and located adjacent the top edge. A second portion of the width of the inside surface of the base layer includes a second tacky adhesive layer connected to the inside surface and located adjacent the bottom edge. At least a portion of the base layer includes a water impermeable area that prevents water adjacent the outside surface from reaching the inside surface by passing through the base layer. And, a third portion of the width of the inside surface of the base layer includes a non-tacky area located between the first tacky adhesive layer and the second tacky adhesive layer

In another aspect, there is provided an alternate tape to mask a structure. The tape includes a base layer having a length, a width, an outside surface, an inside surface, and a top edge spaced from a bottom edge. A first portion of the width of the inside surface of the base layer includes a first tacky adhesive layer connected to the inside surface and located adjacent the top edge. A first portion of the width of the outside surface of the base layer includes a third tacky adhesive layer connected to the outside surface and located adjacent the bottom edge. At least a portion of the base layer includes a water impermeable area that prevents water adjacent the outside surface from reaching the inside surface by passing through the base layer. And, a second portion of the width of the outside surface of the base layer includes a non-tacky area located adjacent the second tacky adhesive layer.

Also described herein are aspects concerning a process, which preferably includes providing a tape having a length, a width, an outside surface, an inside surface, and a top edge spaced from a bottom edge. Another step is adhering a portion of the width of the inside surface of the tape at the top edge to the structure. And, another step is securing a cover sheet to one of the outside surface or the inside surface of the tape adjoining the bottom edge to form a cover sheet secured area. Further, there is the step preventing a second portion of the width of the tape from securing to the cover sheet by utilizing a non-tacky area in a portion of the width of the tape on a same one of the outside surface or the inside surface as the cover sheet secured area.

Other aspects of the disclosure are directed to configurations and features for the adhesive layer, adhesive free area(s), tacky and non-tacky aspects, the tape as a roll of tape, construction of the layers and Adhesion Value for certain combinations of layers

As used herein, the “Adhesion Value Test” is that set forth in industry test ASTM D3330/D3330M-04(Reapproved 2018) titled: Peel Adhesion of Pressure-Sensitive Tape, and the protocol set forth as Test Method A (Single-Coated Tapes, Peel Adhesion at 180 degree Angle) and documents referenced therein, for measuring the Adhesion Value of a layer of material (e.g., tape) having an adhesive layer connected to the layer of material, and using such Adhesion Value Test for all of the layer configurations disclosed herein when an Adhesion Value is needed.

As used herein, “connected” and formatives thereof, means a layer of adhesive joined to a layer of material such that mechanical separation of the two layers unintentionally tears at least a portion of one of the layers so joined together.

As used herein, “removably attached” means a layer of material joined to a layer of adhesive such that mechanical separation of the two layers does not substantially alter the surface of either the layer of material or the layer of adhesive and they can be attached and removed from each other at least once without substantially altering the surface of either layer.

As used herein, a “tacky adhesive layer” means a layer of adhesive that is connected to a surface of a layer of material and then that combination has an Adhesion Value of at least ten ounces/inch (Newtons/25 mm) as measured when separating the layer of material with the adhesive layer connected thereto from the stated stainless steel panel surface in the Adhesion Value Test (defined herein).

As used herein, “non-tacky” means a layer of material, with or without an adhesive layer joined to its surface, and then that combination (or just the layer of material without adhesive) has an Adhesion Value of less than ten ounces/inch (Newtons/25 mm) as measured when separating the layer of material, with or without adhesive joined thereto, from the stated stainless steel panel surface in the Adhesion Value Test (defined herein).

### BRIEF DESCRIPTION OF THE DRAWINGS

The invention may be more completely understood in consideration of the following detailed description of various aspects of the invention in connection with the accompanying drawings, in which:

FIG. 1 is a perspective view of a roll of tape to mask a structure;

FIG. 2 is a perspective view of an alternate roll of tape to mask a structure;

FIG. 3 is a perspective view of yet an alternate roll of tape to mask a structure;

FIG. 4 is a cross-sectional enlarged view of that portion of the tape seen in FIG. 1 taken along the line 4-4;

FIG. 5 is a cross-sectional enlarged view of that portion of the tape seen in FIG. 2 taken along the line 5-5;

FIG. 6 is a cross-sectional enlarged view of that portion of the tape seen in FIG. 3 taken along the line 6-6;

FIG. 7 is a cross-sectional enlarged view of that portion of the tape seen in FIG. 1 taken along the line 4-4, but now showing alternate layer configurations for that area;

FIG. 8 is a cross-sectional enlarged view of that portion of the tape seen in FIG. 3 taken along the line 6-6, but now showing alternate layer configurations for that area;

FIG. 9 is a cross-sectional enlarged view of that portion of the tape seen in FIG. 3 taken along the line 6-6, but now showing yet alternate layer configurations for that area;

FIG. 10 is a perspective view of a few steps of a method to mask the surface; and,

FIG. 11 is a perspective view of additional steps of the method to mask the surface.

The drawings show some but not all embodiments. The elements depicted in the drawings are illustrative and not necessarily to scale, and the same (or similar) reference numbers denote the same (or similar) features throughout the drawings, though all the same (or similar) features are not always separately numbered to help avoid over numbering and obscuring what the drawings are disclosing.

### DETAILED DESCRIPTION

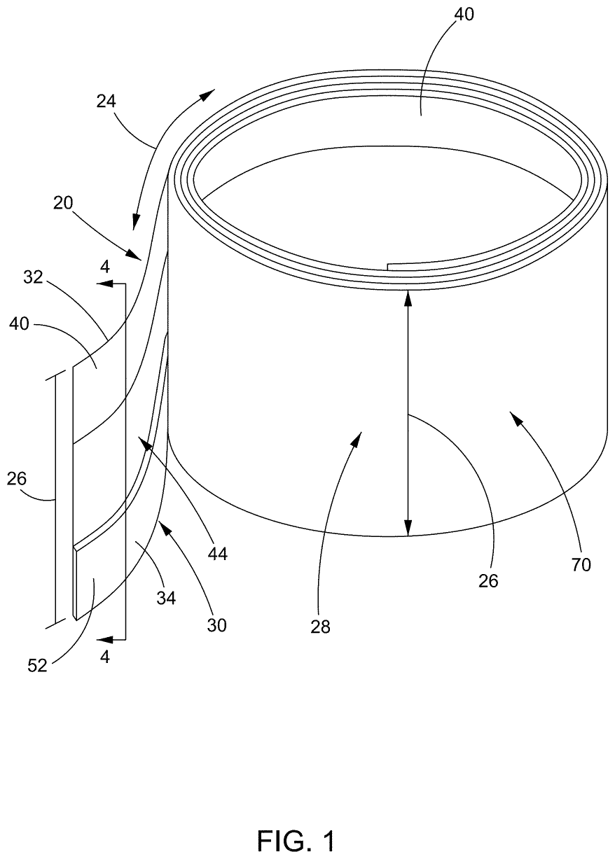

In accordance with practice of the innovative tape 20, as seen in the Figures, for example, FIGS. 1-2 and 4-5, there is tape 20 to mask structure 10. Tape 20 includes a base layer 22 having a length 24, a width 26, an outside surface 28, an inside surface 30, and a top edge 32 spaced from a bottom edge 34. The orientation of inside and outside as used herein is relative to how the tape 20 is adhered to the structure 10, such that the inside surface 30 faces and is at least partially adhered to structure 10 and outside surface 28 generally faces away from structure 10. A first portion of the width of the inside surface of the base layer has a first tacky adhesive layer 40 connected to the inside surface 30 and located adjacent the top edge 32. A second portion of the width of the inside surface of the base layer has a second tacky adhesive layer 50 connected to the inside surface 30 and located adjacent the bottom edge 34. At least a portion of the base layer has a water impermeable area that prevents water adjacent the outside surface 28 from reaching the inside surface 30 by passing through the base layer. A third portion of the width of the inside surface 30 of the base layer has a non-tacky area 44 located between the first tacky adhesive layer 40 and the second tacky adhesive layer 50.

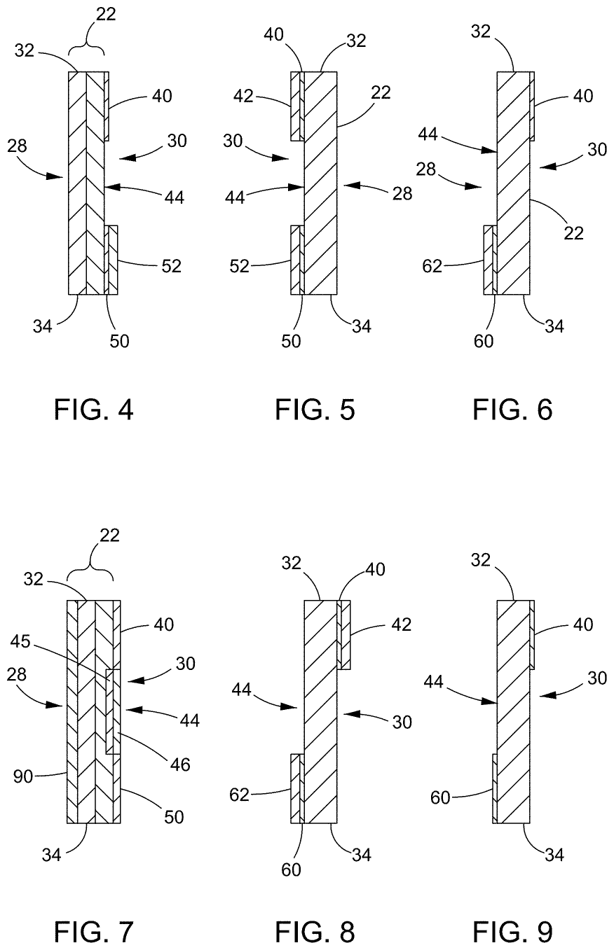

Other aspects of tape 20 are directed to optional and/or preferred features or configurations of the tacky adhesive layer and the non-tacky layer. For example, as seen in FIGS. 1, 2, 4 and 5, a second non-tacky layer 52 can be removably attached to the second tacky adhesive layer 50. Such layer 52 itself has a non-tacky surface that is, preferably, substantially free of any adhesive that would mechanically join one layer to another layer with adhesive therebetween. For example, such a material known as any conventional peel tape, e.g., a material with non-tacky glossy smooth surface or a non-tacky silicone coated paper or filmic material with an Adhesion Value closer to zero. In a similar regard, the non-tacky area 44, preferably, is a substantially adhesive-free zone of the inside surface 30. For example, this can be accomplished by an exposed non-tacky surface like seen in FIGS. 4-6 and 8-9. Or, as in FIG. 7 for another example, by a separate material 46 having a non-tacky outer surface 44, and the material 46 joined to adhesive layer 45 joined between base layer 22 and cover layer 46. Yet further in this regard, tape 20 can include a first non-tacky layer 42 removably attached to the first tacky adhesive layer 42, as seen in FIGS. 5 and 8.

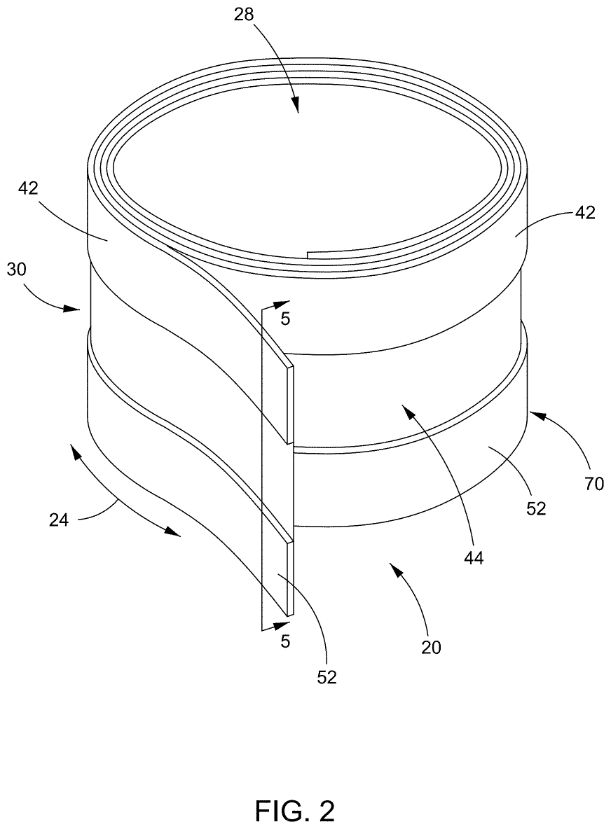

In yet other aspects, tape 20 can be formed into a roll 70 of the tape with the base layer 22 rolled upon itself where the first tacky adhesive layer 40 is removably attached to the outside surface 28 of the base layer, as seen in FIGS. 1 and 4. Additionally here, the second tacky adhesive layer 50 can be removably attached to the outside surface 28 of the base layer, as in FIG. 7, which depicts an alternate layer configuration for the layers of FIG. 1 (not specifically shown in the FIG. 7 layer configuration, but could be made into such a roll based on the teaching herein). As an alternate to FIG. 7 configuration, roll 70 can include second non-tacky layer 52 removably attached to the second tacky adhesive layer 50, and the second non-tacky layer 52 is adjacent to the outside surface 28 of the base layer, as seen in FIGS. 1 and 2. Alternatively, roll 70 can include first non-tacky layer 42 removably attached to the first tacky adhesive layer 40, and the first non-tacky layer 42 being adjacent to the outside surface 28 of the base layer, as seen in FIGS. 2 and 5. Additionally here, roll 70 can further include second non-tacky layer 52 removably attached to the second tacky adhesive layer 50, and the second non-tacky layer 52 is adjacent to the outside surface 28 of the base layer, as seen in FIGS. 2 and 5.

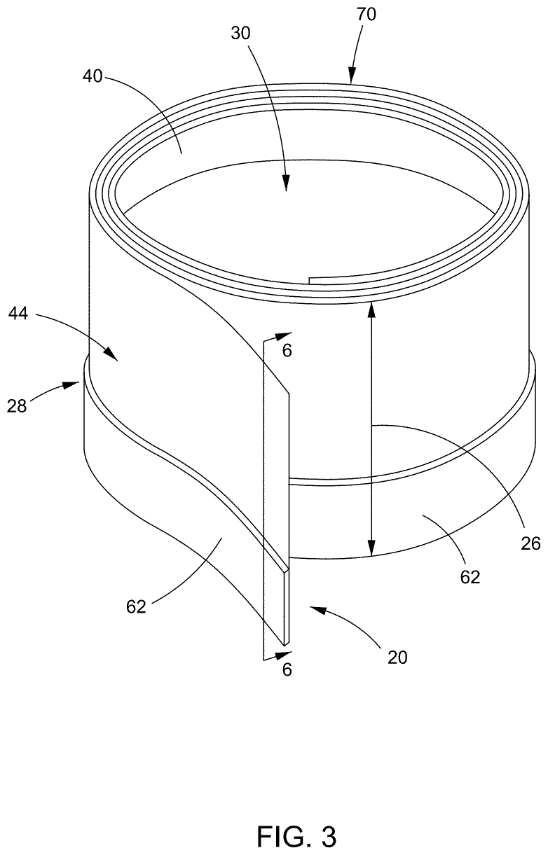

As seen in the Figures, for example, FIGS. 3 and 6, there is tape 20 to mask structure 10. Tape 20 includes base layer 22 having length 24, width 26, outside surface 28, inside surface 30, and top edge 32 spaced from bottom edge 34. A first portion of the width of the inside surface of the base layer has a first tacky adhesive layer 40 connected to the inside surface 30 and located adjacent the top edge 32. A first portion of the width of the outside surface of the base layer has a third tacky adhesive layer 60 connected to the outside surface 28 and located adjacent the bottom edge 34. At least a portion of the base layer has a water impermeable area that prevents water adjacent the outside surface 28 from reaching the inside surface 30 by passing through the base layer. A second portion of the width of the outside surface 30 of the base layer has a non-tacky area 44 located adjacent the second tacky adhesive layer 52.

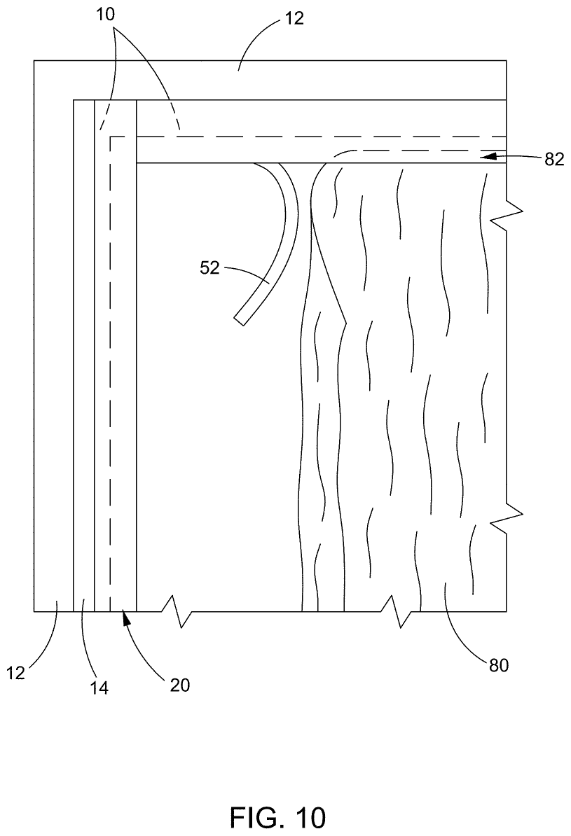

Building upon that seen in FIGS. 3 and 6, as well as alternatives seen in FIGS. 8 and 9, other features of the tape 20 can be employed as desired. For example, third non-tacky layer 62 can be removably attached to the third tacky adhesive layer 60. Additionally, or alternatively, tape 20 can include first non-tacky layer 42 removably attached to the first tacky adhesive layer 40, as seen in FIG. 8 which depicts an alternate layer configuration for the layers of FIG. 3 (not specifically shown in the FIG. 8 layer configuration, but could be made into such a roll based on the teaching herein). Additionally or alternatively, and similar to the prior discussion for non-tacky area 44, area 44 can be a substantially adhesive-free zone of the inside surface, as opposed to an adhesive zone covered by a material to form a non-tacky outermost surface.

In still other aspects, tape 20 can be formed into a roll 70 of the tape with the base layer 22 rolled upon itself where the first tacky adhesive layer 40 is removably attached to the outside surface of the base layer, as seen in FIG. 6, and also would be possible with the FIG. 9 which depicts an alternate layer configuration for the layers of FIG. 3 (not specifically shown in the FIG. 9 layer configuration, but could be made into such a roll based on the teaching herein). Alternatively, roll 70 can include first non-tacky layer 42 removably attached to the first tacky adhesive layer 40, and where the first non-tacky layer 42 is adjacent to the outside surface 28 of the base layer, as seen in FIG. 8. Alternately, the third tacky adhesive layer 60 can be removably attached to the inside surface of the base layer, as seen in FIG. 9. Yet alternately, roll 70 can include a third non-tacky layer 62 removably attached to the third tacky adhesive layer 60, and where the third non-tacky layer 62 is adjacent to the inside surface 30 of the base layer.

Turing to the construction of the tape, the base layer 22 can be made of a non-woven material, and preferably can be manually torn like a conventional masking tape. For example, such a nonwoven material could be a paper-formed material, like flat paper, creeped paper or other type of coated paper. Additionally, or alternatively, the water impermeable area can be formed by a water barrier layer 90, such as a coating forming layer 90 applied and connected with the base layer, or a liquid impregnated into the base layer to make it at least partially, and preferably near completely, water impermeable. Additionally, or alternatively, the water impermeable area can include a pre-formed film layer connected with the base layer, like layer 90, that could be located as seen in FIG. 7, or in other locations across layer 22 closer to inside surface 30. As an alternative to a paper-formed material base layer, and also not generally considered a non-woven material, base layer 22 can be a film layer (looking like and located similar to layer 90), and more preferably a water impermeable film. Still further, preferably, and regardless how the base layer is made water impermeable, such impermeability is across some to most, and most preferably all, of the length and width of tape 20.

In regard to the tacky adhesive layers, they can be formed from any conventional adhesive materials, e.g., pressure sensitive adhesive, always tacky adhesive, triggerable tacky adhesive, as long as the applied adhesive layer has the properties, and is applied in one of the configurations, as taught herein. For example, this commercially available paper and adhesive materials, i.e., tape, can be used when modified as taught herein to practice the claimed disclosure: PG21™ of Intertape Polymer Group® located in Sarasota, Fla. (and such material being a backing of fine crepe paper with a rubber/resin adhesive applied to one side thereof, having an Adhesion Value of 28 ounces/inch (7.7 Newtons/25 mm), a tensile strength of 26 pounds/inch (114 Newtons/25 mm), an elongation at break of ten percent, and a total thickness of 7.3 mils (0.185 mm)). Further, as an exemplary layer of material with a tacky adhesive layer connected thereto, the second or third tacky adhesive layers 50, 60 connected to the surfaces 30, 28 respectively, of the base layer 22 have an Adhesion Value of between, preferably from ten ounces/inch (Newtons/25 mm) to about forty ounces/inch (Newtons/25 mm)(but not limited to this upper end), more preferably from about twenty ounces/inch (Newtons/25 mm) to about thirty-five ounces/inch (Newtons/25 mm), and most preferably from about twenty-five ounces/inch (Newtons/25 mm) to about thirty ounces/inch (Newtons/25 mm), all as measured when separating the tacky adhesive layer connected to the respective inside or outside surface of tape 20 from the stainless steel panel surface in the Adhesion Value Test defined above.

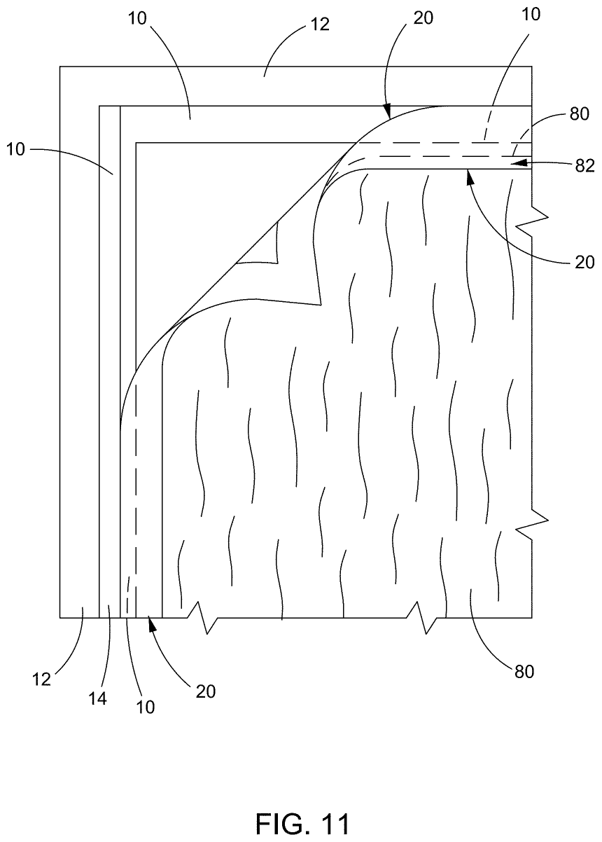

Referring to FIGS. 10-11, as well as general to the prior figures, a method to mask a structure 10 is disclosed. Structure 10 can be any surface, and preferably is a building surface like a door opening, window opening or other opening that needs temporary coverage during construction or renovation of the structure, for painting, finishing or other building process. Without being limited to a theory of understanding, the inventor has found that employing his new tape 20, and preferably as discussed herein, makes masking/covering a structure more efficient and/or secure and/or protective to the underlying structure, than ever before possible. This saves time during installation, as well as when unmasking/uncovering for further use of the structure as intended.

The method includes providing a tape, like tape 20 discussed here, having length 24, width 26, outside surface 28, inside surface 30, and top edge 32 spaced from bottom edge 34. Another step is adhering a portion of the width of the inside surface 30 of the tape 20 at the top edge 32 to the structure 10, as seen in the FIG. 10 with upper left corner of an opening like a window frame 12. A further step is securing cover sheet 80 to one of the outside surface 28 or the inside surface 30 of the tape 20 adjoining the bottom edge 32 to form a cover sheet secured area. And, another step is preventing a second portion of the width of the tape 20 from securing to the cover sheet 80 by utilizing non-tacky area 44 in a portion of the width of the tape 20 on a same one of the outside surface 28 or the inside surface 30 as the cover sheet secured area 82.

As used herein, “adhering” includes at least some adhesive and that adhesive and the material layer to which it is attached has more Adhesion Value than a non-tacky area, preferably has an Adhesion Value greater than fifteen ounces/inch (Newtons/25 mm), and most preferably has an Adhesion Value no more than about forty ounces/inch (Newtons/25 mm). As used herein, a “secured area” and “securing” has at least some adhesive and that adhesive and the material layer to which it is attached has an Adhesion Value greater than ten ounces/inch (Newtons/25 mm), and preferably has an Adhesion Value of at least fifteen ounces/inch (Newtons/25 mm), and most preferably has an Adhesion Value of at least twenty ounces/inch (Newtons/25 mm).

In other aspects, the method can also include securing the cover sheet 82 to the inside surface 30 of the tape, as seen in FIG. 10. Alternatively, the method could be securing the cover sheet 82 to the outside surface 28 of the tape, as in FIG. 11. And, as an additional step for either of these prior two alternative steps, the method can include removing a non-tacky layer from an adhesive layer connected to one of the outside surface (e.g., third non-tacky layer 62) of the tape or the inside surface (e.g., second non-tacky layer 52) of the tape and then securing the cover sheet 82 to the adhesive layer (e.g., layers 50, 60 respectively). Additionally, or alternately, the step adhering the portion of the width of the inside surface 30 of the tape can precede the step securing the cover sheet 82, as seen in the left most portion of FIG. 10 where tape 20 is adhered to a window surface of structure 10 before the cover sheet is secured with tape 20. Additionally, another step can be installing additional structure, like dry wall 14, over the portion of the width of the outside surface 28 of the tape at the top edge 32 that is adhering to the structure 10, as seen in FIG. 10 along the left side. And additionally, another step can be removing at least a portion of the tape 20 securing the cover sheet to the tape, as seen in FIG. 11 upper left corner area. Yet still additionally, the method can include the step leaving in place at least a portion of the width of the inside surface of the tape at the top edge 32 that is adhering to the structure, as seen in FIG. 11 for that portion of the tape 20 located between the bottom edge of dry wall 14 sitting on top of the outside surface 28 of tape 20 and the upper surface of window structure 10, thereby sandwiching tape 20 in place here.

Additional discussion of disclosure in various scopes now follows:

A. A tape to mask a structure. The tape includes a base layer having a length, a width, an outside surface, an inside surface, and a top edge spaced from a bottom edge. A first portion of the width of the inside surface of the base layer includes a first tacky adhesive layer connected to the inside surface and located adjacent the top edge. A second portion of the width of the inside surface of the base layer includes a second tacky adhesive layer connected to the inside surface and located adjacent the bottom edge. At least a portion of the base layer includes a water impermeable area that prevents water adjacent the outside surface from reaching the inside surface by passing through the base layer. And, a third portion of the width of the inside surface of the base layer includes a non-tacky area located between the first tacky adhesive layer and the second tacky adhesive layer.
B. The tape of any of the prior disclosure, further comprising a second non-tacky layer removably attached to the second tacky adhesive layer.
C. The tape of any of the prior disclosure, wherein the non-tacky area comprises a substantially adhesive-free zone of the inside surface.
D. The tape of any of the prior disclosure, further comprising a first non-tacky layer removably attached to the first tacky adhesive layer.
E. The tape of any of the prior disclosure, further comprising a roll of the tape with the base layer rolled upon itself wherein the first tacky adhesive layer is removably attached to the outside surface of the base layer.
F. The tape of any of the prior disclosure, further comprising a roll of the tape with the base layer rolled upon itself wherein a first non-tacky layer is removably attached to the first tacky adhesive layer and wherein the first non-tacky layer is adjacent to the outside surface of the base layer.
G. The tape of any of the prior disclosure, further comprising a second non-tacky layer removably attached to the second tacky adhesive layer and wherein the second non-tacky layer is adjacent to the outside surface of the base layer.
H. The tape of any of the prior disclosure, wherein the second tacky adhesive layer is removably attached to the outside surface of the base layer.
I. The tape of any of the prior disclosure, further comprising a second non-tacky layer removably attached to the second tacky adhesive layer and wherein the second non-tacky layer is adjacent to the outside surface of the base layer.
J. The tape of any of the prior disclosure, wherein the base layer comprises a non-woven material.
K. The tape of any of the prior disclosure, wherein the non-woven material is a paper-formed material.
L. The tape of any of the prior disclosure, wherein the water impermeable area comprises a water barrier layer of coating applied and connected with the base layer.
M. The tape of any of the prior disclosure, wherein the base layer comprises a water impermeable film.
N. The tape of any of the prior disclosure, wherein the water impermeable area comprises a pre-formed film layer connected with the base layer.
O. The tape of any of the prior disclosure, wherein the second tacky adhesive layer connected to the inside surface of the base layer has an Adhesion Value of between ten ounces/inch (Newtons/25 mm) to about forty ounces/inch (Newtons/25 mm) as measured when separating the second tacky adhesive layer connected to the inside surface with a stated surface in the Adhesion Value Test.
P. An alternate tape to mask a structure. The tape includes a base layer having a length, a width, an outside surface, an inside surface, and a top edge spaced from a bottom edge. A first portion of the width of the inside surface of the base layer includes a first tacky adhesive layer connected to the inside surface and located adjacent the top edge. A first portion of the width of the outside surface of the base layer includes a third tacky adhesive layer connected to the outside surface and located adjacent the bottom edge. At least a portion of the base layer includes a water impermeable area that prevents water adjacent the outside surface from reaching the inside surface by passing through the base layer. And, a second portion of the width of the outside surface of the base layer includes a non-tacky area located adjacent the second tacky adhesive layer.
Q. The tape of any of the alternate tape prior disclosure, further comprising a third non-tacky layer removably attached to the third tacky adhesive layer.
R. The tape of any of the alternate tape prior disclosure, wherein the non-tacky area comprises a substantially adhesive-free zone of the inside surface.
S. The tape of any of the alternate tape prior disclosure, further comprising a first non-tacky layer removably attached to the first tacky adhesive layer.
T. The tape of any of the alternate tape prior disclosure, further comprising a roll of the tape with the base layer rolled upon itself wherein the first tacky adhesive layer is removably attached to the outside surface of the base layer.
U. The tape of any of the alternate tape prior disclosure, further comprising a roll of the tape with the base layer rolled upon itself wherein a first non-tacky layer is removably attached to the first tacky adhesive layer and wherein the first non-tacky layer is adjacent to the outside surface of the base layer.
V. The tape of any of the alternate tape prior disclosure, wherein the third tacky adhesive layer is removably attached to the inside surface of the base layer.
W. The tape of any of the alternate tape prior disclosure, further comprising a roll of the tape with the base layer rolled upon itself wherein a third non-tacky layer is removably attached to the third tacky adhesive layer and wherein the third non-tacky layer is adjacent to the inside surface of the base layer.
X. The tape of any of the alternate tape prior disclosure, wherein the third tacky adhesive layer connected to the outside surface of the base layer has an Adhesion Value of between ten ounces/inch (Newtons/25 mm) to about forty ounces/inch (Newtons/25 mm) as measured when separating the third tacky adhesive layer connected to the outside surface with a stated surface in the Adhesion Value Test.
Y. A method to mask a structure. The method includes providing a tape having a length, a width, an outside surface, an inside surface, and a top edge spaced from a bottom edge. Another step is adhering a portion of the width of the inside surface of the tape at the top edge to the structure. And, another step is securing a cover sheet to one of the outside surface or the inside surface of the tape adjoining the bottom edge to form a cover sheet secured area. Further, there is the step preventing a second portion of the width of the tape from securing to the cover sheet by utilizing a non-tacky area in a portion of the width of the tape on a same one of the outside surface or the inside surface as the cover sheet secured area.
Z. The method of any of the prior method disclosure, wherein securing the cover sheet comprises securing to the inside surface of the tape.
AA. The method of any of the prior method disclosure, wherein securing the cover sheet comprises securing to the outside surface of the tape.
BB. The method of any of the prior method disclosure, wherein the step adhering a portion of the width of the inside surface of the tape precedes the step securing the cover sheet.
CC. The method of any of the prior method disclosure, further comprising removing a non-tacky layer from an adhesive layer connected to one of the outside surface of the tape or the inside surface of the tape and then securing the cover sheet to the adhesive layer.
DD. The method of any of the prior method disclosure, further comprising installing additional structure over the portion of the width of the inside surface of the tape at the top edge that is adhering to the structure.
EE. The method of any of the prior method disclosure, further comprising removing at least a portion of the tape securing the cover sheet to the tape.
FF. The method of any of the prior method disclosure, further comprising leaving in place at least a portion of the width of the inside surface of the tape at the top edge that is adhering to the structure.

Each and every document cited in this present application, including any cross referenced or related patent or application, is incorporated in this present application in its entirety by this reference, unless expressly excluded or otherwise limited. The citation of any document is not an admission that it is prior art with respect to any embodiment disclosed in this present application or that it alone, or in any combination with any other reference or references, teaches, suggests, or discloses any such embodiment. Further, to the extent that any meaning or definition of a term in this present application conflicts with any meaning or definition of the same term in a document incorporated by reference, the meaning or definition assigned to that term in this present application governs.

The present invention includes the description, examples, embodiments, and drawings disclosed; but it is not limited to such description, examples, embodiments, or drawings. As briefly described above, the reader should assume that features of one disclosed embodiment can also be applied to all other disclosed embodiments, unless expressly indicated to the contrary. Unless expressly indicated to the contrary, the numerical parameters set forth in the present application are approximations that can vary depending on the desired properties sought to be obtained by a person of ordinary skill in the art without undue experimentation using the teachings disclosed in the present application. Modifications and other embodiments will be apparent to a person of ordinary skill in the hotmelt adhesive equipment arts, and all such modifications and other embodiments are intended and deemed to be within the scope of the present invention.

What is claimed is:

1. A tape to mask a structure, comprising:
a base layer having a length, a width, an outside surface, an inside surface, and a top edge spaced from a bottom edge;
a first portion of the width of the inside surface of the base layer comprising a first tacky adhesive layer connected to the inside surface and located adjacent the top edge;
a second portion of the width of the inside surface of the base layer comprising a second tacky adhesive layer connected to the inside surface and located adjacent the bottom edge;
at least a portion of the base layer comprising a water impermeable area that prevents water adjacent the outside surface from reaching the inside surface by passing through the base layer; and,
a third portion of the width of the inside surface of the base layer comprising a non-tacky area located between the first tacky adhesive layer and the second tacky adhesive layer.

2. The tape of claim 1, further comprising a second non-tacky layer removably attached to the second tacky adhesive layer.

3. The tape of claim 1, wherein the non-tacky area comprises a substantially adhesive-free zone of the inside surface.

4. The tape of claim 1, further comprising a first non-tacky layer removably attached to the first tacky adhesive layer.

5. The tape of claim 1, further comprising a roll of the tape with the base layer rolled upon itself wherein the first tacky adhesive layer is removably attached to the outside surface of the base layer.

6. The tape of claim 1, further comprising a roll of the tape with the base layer rolled upon itself wherein a first non-tacky layer is removably attached to the first tacky adhesive layer and wherein the first non-tacky layer is adjacent to the outside surface of the base layer.

7. The tape of claim 6, further comprising a second non-tacky layer removably attached to the second tacky adhesive layer and wherein the second non-tacky layer is adjacent to the outside surface of the base layer.

8. The tape of claim 5 wherein the second tacky adhesive layer is removably attached to the outside surface of the base layer.

9. The tape of claim 5, further comprising a second non-tacky layer removably attached to the second tacky adhesive layer and wherein the second non-tacky layer is adjacent to the outside surface of the base layer.

10. The tape of claim 1, wherein the base layer comprises a non-woven material.

11. The tape of claim 10, wherein the non-woven material is a paper-formed material.

12. The tape of claim 1, wherein the water impermeable area comprises a water barrier layer of coating applied and connected with the base layer.

13. The tape of claim 1, wherein the base layer comprises a water impermeable film.

14. The tape of claim 1, wherein the water impermeable area comprises a pre-formed film layer connected with the base layer.

15. The tape of claim 1, wherein the second tacky adhesive layer connected to the inside surface of the base layer has an Adhesion Value of between ten ounces/inch (Newtons/25 mm) to about forty ounces/inch (Newtons/25 mm) as measured when separating the second tacky adhesive layer connected to the inside surface with a stated surface in the Adhesion Value Test.

16. A tape to mask a structure, comprising:
a base layer having a length, a width, an outside surface, an inside surface, and a top edge spaced from a bottom edge;
a first portion of the width of the inside surface of the base layer comprising a first tacky adhesive layer connected to the inside surface and located adjacent the top edge;
a first portion of the width of the outside surface of the base layer comprising a third tacky adhesive layer connected to the outside surface and located adjacent the bottom edge;
at least a portion of the base layer comprising a water impermeable area that prevents water adjacent the outside surface from reaching the inside surface by passing through the base layer; and,
a second portion of the width of the outside surface of the base layer comprising a non-tacky area located adjacent the second tacky adhesive layer.

17. The tape of claim 16, further comprising a third non-tacky layer removably attached to the third tacky adhesive layer.

18. The tape of claim 16, wherein the non-tacky area comprises a substantially adhesive-free zone of the inside surface.

19. The tape of claim 16, further comprising a first non-tacky layer removably attached to the first tacky adhesive layer.

20. The tape of claim 16, further comprising a roll of the tape with the base layer rolled upon itself wherein the first tacky adhesive layer is removably attached to the outside surface of the base layer.

21. The tape of claim 16, further comprising a roll of the tape with the base layer rolled upon itself wherein a first non-tacky layer is removably attached to the first tacky adhesive layer and wherein the first non-tacky layer is adjacent to the outside surface of the base layer.

22. The tape of claim 16, wherein the third tacky adhesive layer is removably attached to the inside surface of the base layer.

23. The tape of claim 16, further comprising a roll of the tape with the base layer rolled upon itself wherein a third non-tacky layer is removably attached to the third tacky adhesive layer and wherein the third non-tacky layer is adjacent to the inside surface of the base layer.

24. The tape of claim 16, wherein the third tacky adhesive layer connected to the outside surface of the base layer has an Adhesion Value of between ten ounces/inch (Newtons/25 mm) to about forty ounces/inch (Newtons/25 mm) as measured when separating the third tacky adhesive layer connected to the outside surface with a stated surface in the Adhesion Value Test.

25. A method to mask a structure, comprising:
providing a tape having a length, a width, an outside surface, an inside surface, and a top edge spaced from a bottom edge;
adhering a portion of the width of the inside surface of the tape at the top edge to the structure;
securing a cover sheet to one of the outside surface or the inside surface of the tape adjoining the bottom edge to form a cover sheet secured area; and,
preventing a second portion of the width of the tape from securing to the cover sheet by utilizing a non-tacky area in a portion of the width of the tape on a same one of the outside surface or the inside surface as the cover sheet secured area.

26. The method of claim 25, wherein securing the cover sheet comprises securing to the inside surface of the tape.

27. The method of claim 25, wherein securing the cover sheet comprises securing to the outside surface of the tape.

28. The method of claim 25, wherein the step adhering a portion of the width of the inside surface of the tape precedes the step securing the cover sheet.

29. The method of claim 25, further comprising removing a non-tacky layer from an adhesive layer connected to one of the outside surface of the tape or the inside surface of the tape and then securing the cover sheet to the adhesive layer.

30. The method of claim 25, further comprising installing additional structure over the portion of the width of the inside surface of the tape at the top edge that is adhering to the structure.

31. The method of claim 25, further comprising removing at least a portion of the tape securing the cover sheet to the tape.

32. The method of claim 31, further comprising leaving in place at least a portion of the width of the inside surface of the tape at the top edge that is adhering to the structure.
